(19) United States
(12) Patent Application Publication
(10) Pub. No.: US 2004/0021794 A1
(43) Pub. Date: Feb. 5, 2004

(54) Video display apparatus

(76) Inventors: Yoshiaki Nakayama, Chigasaki (JP); Katsuya Fujii, Fujisawa (JP); Hisaya Fukumoto, Tsuyama (JP)

Correspondence Address: MCDERMOTT WILL & EMERY, 600 13TH STREET, N.W., WASHINGTON, DC, 20005-3096, US

(21) Appl. No.: 10/440,420

(22) Filed: May 19, 2003

(30) Foreign Application Priority Data
May 20, 2002 (JP) 2002-143986

(51) Int. Cl. H04N 7/00; H04N 11/00

(52) U.S. Cl. 348/468

(57) ABSTRACT

The video display apparatus of the present invention detects a vertical picture size steadily and displays a picture from a video signal accompanied by a closed caption, so that the closed caption does not fall out of the display screen. A closed caption decoder extracts a start line code which determines a position from which a horizontal scan starts along a vertical axis of an active picture area of the video signal and an end line code which determines a position at which the horizontal scan terminates. Based on the start line code and the end line code, a vertical picture size is calculated, and position in which the closed caption information is to be displayed is controlled, according to the vertical picture size.

### BACKGROUND OF THE INVENTION

The present invention relates to a television receiver including a closed caption decoder, provided with a control function for displaying a video picture with its accompanying closed caption presented in position within the height of the picture, according to a picture zoom ratio.

Previous television receivers including a closed caption decoder have been known. When these television receivers with a zoom function and an aspect ratio (the ratio of width to height of a video picture), for example, 16:9, display an enlarged view of a video picture of vista size, they can also display its accompanying closed caption information, avoiding that the caption information falls out of their display screen. For example, such a television receiver has been disclosed in a publication, JP-A No. 93932/1998.

FIG. 4 is a block diagram showing the television receiver configuration including a closed caption decoder, disclosed in the above-mentioned publication.

In the television receiver shown in FIG. 4, an video signal generating unit 1 demodulates a television signal received by, for example, a channel selection unit which is not shown and outputs a video signal in which a closed caption signal has been embedded in the vertical blanking interval (VBI). The closed caption signal added to the video signal on line 21 of the VBI contains text information (or caption information) and visualization control data including on-screen position in which the text information (or caption information) is to be displayed. For plain description, text information, when solely mentioned, will be assumed including caption information hereinafter.

A picture size detecting unit 60 detects a vertical picture size from the video signal passed from the video signal generating unit 1. A closed caption decoder 20 decodes the closed caption signal embedded in the VBI of the video signal and extracts and decodes closed caption visualization control data and passes these decoded signal and data to a microcomputer 40.

The microcomputer 40 calculates an optimum picture zoom ratio, based on the picture size supplied from the picture size detecting unit 60 and the closed caption visualization control data from the closed caption decoder 20 and outputs the calculated zoom ratio to a deflection control unit 3 which performs deflection control for a cathode ray tube 5 display having a wide screen that is long sideways. Also, the microcomputer 40 calculates on-screen position in which text information from the closed caption signal is to be displayed without falling out of the display area and outputs the calculated on-screen position of the text information to the closed caption decoder 20.

The deflection control unit 3 outputs the video signal passed from the video signal generating unit 1, the text information to be displayed in position controlled by the microcomputer 40, passed from the closed caption decoder 20, and the zoom ratio calculated by the microcomputer 40 to the cathode ray tube 5 display, so that the video picture with the accompanying caption is displayed at the zoom ratio.

In the prior art to which the invention pertains, as exemplified above, a vertical picture size is detected from the received video signal and picture zoom ratio calculation is executed, using the picture size.

### SUMMARY OF THE INVENTION

The above-described television receiver with a closed caption decoder, as the prior art example, is constructed to detect a picture size from the received video signal, however, the above-mentioned publication thereof does not refer to the technique for picture size detection.

A problem with the above television receiver is that picture size detection cannot be performed correctly as the case may be, for example, when the television receiver receives a video signal of a low brightness scene or rapid motion scene. In such cases, an incorrect picture size detected makes the zoom ratio vary, which cause the caption from the closed caption signal to get out of the bounds of the actual vertical picture size or become extremely small.

FIG. 5 is provided to explain the above problem. In FIG. 5A, reference numeral 61 denotes the display area of an oblong, wide screen with an aspect ratio (the ratio of width to height) of 16:9 and 62 denotes the display area of a screen with an aspect ratio of 4:3 in the display area 61. Normal TV video signals with an aspect ratio of 4:3 are visualized in the display area 62. Reference numeral 63 denotes a display screen, for example, a vista size screen of a wider aspect ratio, set up in the display area 62 with the aspect ratio of 4:3. On the display screen 63, a white circle image 64 which represents a picture whose brightness level is 100% is displayed at full height of vista size in the vertical direction which intersects orthogonally the horizontal scan direction parallel to the display screen 63 against a background 65 whose brightness level is 0%. Reference numeral 67 denotes a video signal detected in vertical scan periods, the signal corresponding to the thus displayed image. Time is plotted along the vertical scan direction and brightness levels of the video signal are plotted horizontally on the page of the drawing. The vertical picture size 66 of the image thus displayed on the display screen 63 of vista size is equal to the diameter of the circle 64.

In FIG. 5B, reference numeral 64′ denotes a white circle image with a smaller diameter than the height of the display screen 63 of vista size, the brightness level of which is 100%, being displayed against the background 65′ whose brightness level is 0%. Reference numeral 67′ denotes a video signal detected in vertical scan periods, the signal corresponding to the thus displayed image.

For the case of FIG. 5A, the 100% white circle image 64 is displayed in the display area 63 at full height of vista size. The video signal 67 detected in vertical scan periods is obtained by detecting the peak of the signal per horizontal scan period with a peak detector, which is included in the picture size detecting unit 60, though not shown, and slicing the detected peaks in predetermined slice levels. As apparent from FIG. 6A, the vertical picture size 66 of the thus detected video signal in vertical scan periods is steady, equaling to the diameter of the circle image 64. For the case of FIG. 5B, the 100% white circle image 64′ is displayed against the black background 65′ and its vertical picture size 66′ obtained by slicing the video signal 67′ in slice levels 68 is smaller than the actual vertical picture size 66 of the vista size screen. In this case, thus, a correct zoom ratio cannot be obtained. As the size of the circle image 64′ changes rapidly, the vertical picture width cannot be detected correctly for the same reason and the zoom ratio varies. In consequence, the caption from the closed caption signal cannot be displayed properly; it may greatly get out of the bounds of the vertical picture size.

It is an object of the present invention to solve the above-described problem, obtain a steady zoom ratio, and display a video picture with its accompanying closed caption presented within the actual height of the picture.

In order to solve the above-described problem, a video display apparatus of the present invention is configured to comprise means for closed caption decoding, which extracts a closed caption signal embedded in a video signal and derives closed caption information therefrom, means for calculating a vertical picture size corresponding to an active picture area after extracting from the video signal a start line code which determines a position from which a horizontal scan starts along a vertical axis of the active picture area of the video signal and an end line code which determines a position at which the horizontal scan terminates, wherein the start line code and the end line code are included in a data signal embedded in the video signal, and means for controlling position in which the closed caption information is to be displayed on a display screen, according to the vertical picture size.

The thus configured video display apparatus can display a picture accompanied by a closed caption steadily even when a full screen picture, for example, a vista size picture is displayed on a cathode ray tube display.

### BRIEF DESCRIPTION OF THE DRAWINGS

FIG. 1 is a block diagram showing a television receiver configuration including a closed caption decoder in accordance with a preferred embodiment of the present invention;

FIG. 2A shows outlined XDS packet data structure for aspect ratio information;

FIG. 2B shows detailed XDS packet data structure for aspect ratio information;

FIG. 3 is a flowchart illustrating a process flow for controlling on-screen position in which text information is to be displayed, according to the present invention;

FIG. 4 is a block diagram showing a television receiver configuration including a closed caption decoder, according to prior art;

FIG. 5A shows a picture size example without a problem; and

FIG. 5B shows a smaller picture size example which causes a problem of prior art that is solved by the present invention

### DETAILED DESCRIPTION OF PREFERRED EMBODIMENTS

A preferred, illustrative embodiment of the present invention will now be described hereinafter with reference to the accompanying drawings.

Unlike the prior art video display apparatus in which the picture size detecting unit detects a vertical picture size from the received video signal, a video display apparatus of the present invention calculates vertical picture size from a video signal, using certain Extended Data Services (hereinafter abbreviated to XDS) codes which are embedded with a closed caption signal in the video signal. The XDS codes are the start line and end line codes that signal aspect ratio information from which an active picture vertical height is obtained.

The XDS data is added to the video signal on VBI line 21, field 2, which is defined in detail in EIA-608A (EIA:Electronic Industries Association).

The active picture means a picture shown in the active area in which a picture (for example, a moving picture) is actually displayed in the video display area on a display screen.

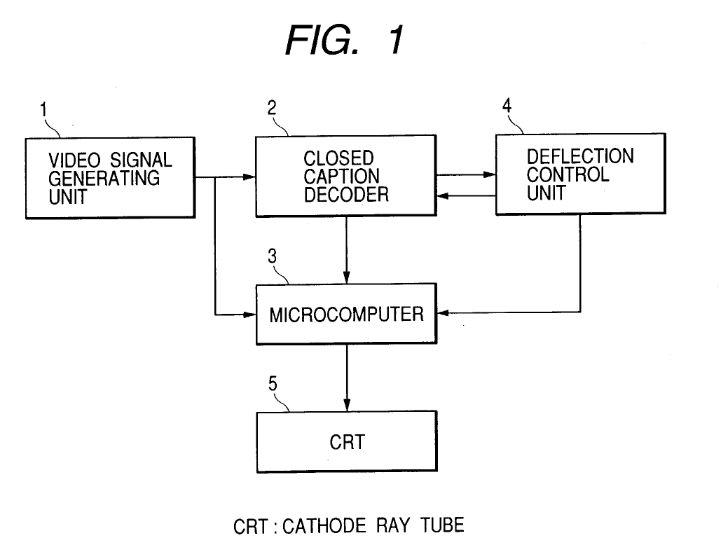

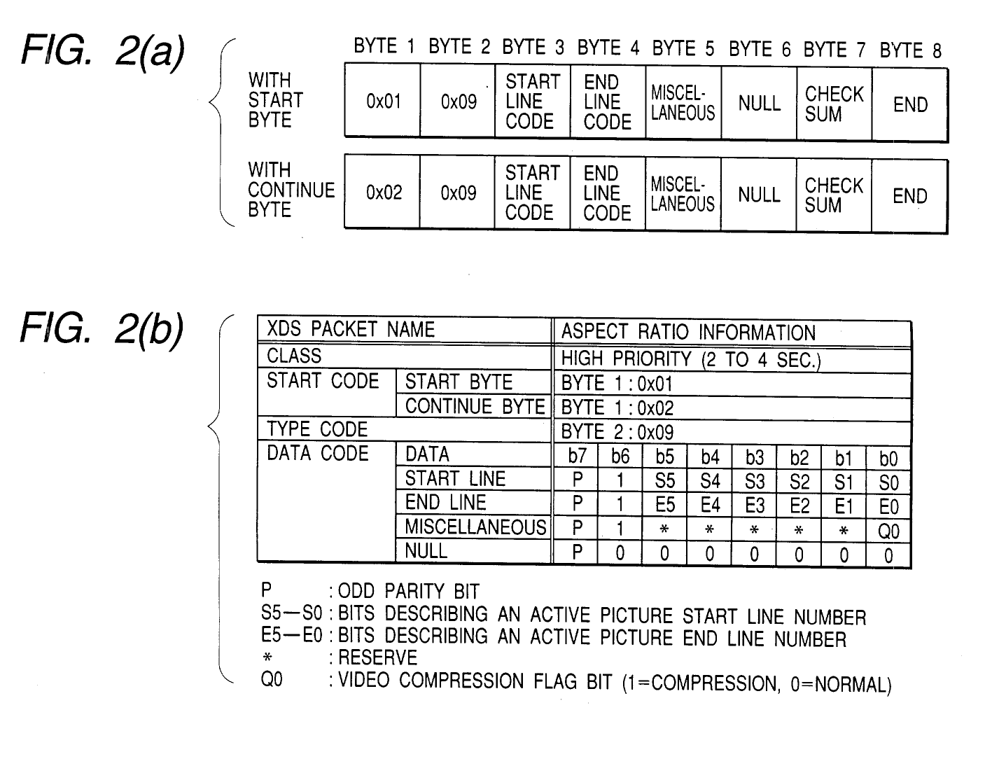

FIG. 1 is a block diagram showing a television receiver configuration including a closed caption decoder in accordance with a preferred embodiment of the present invention. FIGS. 2A and 2B show XDS packet data structure for aspect ratio information.

Using FIGS. 2A and 2B, the XDS packet data structure for aspect ratio information is first described. FIG. 2A shows outlined packet data structure for aspect ratio information. FIG. 2B shows detailed packet data structure including bits.

In FIG. 2A, XDS data which is transmitted in the packet format consists of byte 1 containing 0x01 which is a start byte indicating the start of control for XDS, byte 2 containing 0x09 which indicates that the packet is for aspect ratio information, byte 3 containing a start line code which determines the vertical start position of the active picture, byte 4 containing an end line code which determines the vertical end position of the active picture, byte 5 containing miscellaneous data other than 0, byte 6 which is a null byte, byte 7 which is a checksum code byte, and byte 8 which is an end code byte. On some channel, a closed caption signal which is higher priority of XDS data is added to the video signal on VBI line 21, field 2. In this case, XDS data cannot be transmitted successively and byte 1 contains 0x02 instead of the 0x01 start byte. Bytes 3 to 6 are data bytes containing aspect ratio information, but the data byte length is not necessarily four bytes and may be reduced to two bytes containing the start line code and the end line code, respectively.

Bit configurations for each byte are as shown in FIG. 2B. A start line number (hereinafter represented by NS) which is a vertical start position from which the active picture horizontal scan starts is given by adding 22 to a decimal number (hereinafter represented by Ns) described by the bits S5 to S0 of the start line code. The range of the NS is 22 to 85. An end line number (hereinafter represented by NE) which is a vertical end position at which the active picture horizontal scan terminates is given by subtracting a decimal number (hereinafter represented by Ne) described by the bits E5 to E0 of the end line code from 262. The range of the NE is 199 to 262.

For example, if both the Ns and Ne are 0, NS=22 and NE 262 and a vertical picture size NW is obtained by calculating NW=NE−NS; that is, 262−22=240.

Bit b7 of each data code is a parity bit P and bit 0 of the miscellaneous byte is a video compression flag bit Q0.

Then, the preferred embodiment of the present invention will be fully explained, using FIG. 1 and referring to FIG. 2 if necessary.

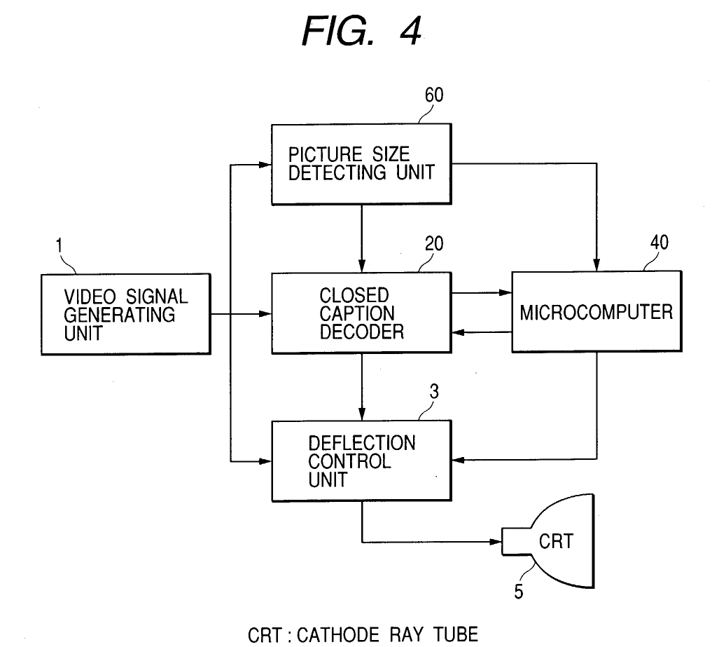

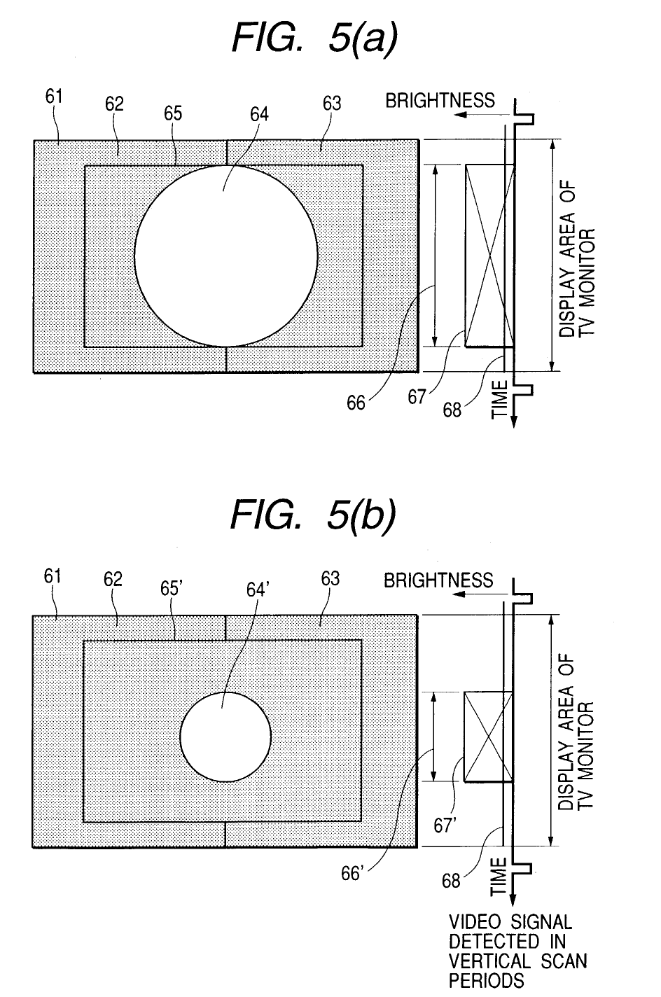

In FIG. 1, reference numeral 2 denotes a closed caption decoder. The closed caption decoder 2 extracts and decodes a closed caption signal added to the video signal on VBI line 21, field 1 or 2 and aspect ratio information in XDS data added to the video signal on VBI line 21, field 2, derives the closed caption data and aspect ratio information, inputs control data for on-screen position in which text information is to be displayed included in the closed caption data and the start line number NS and end line number NE included in the aspect ratio information to a microcomputer 4, and inputs the text information to a deflection control unit 3. The microcomputer 4 calculates an optimum picture zoom ratio, based on the control data for on-screen position in which text information is to be displayed and the start line number NS and end line number NE as the aspect ratio information from the XDS data and outputs the calculated zoom ratio to the deflection control unit which performs deflection control for a cathode ray tube (CRT) 5 display. The microcomputer 4 also calculates an on-screen position in which the text information from the closed caption signal should be displayed, accompanying the video picture, without falling out of the display area, and outputs the on-screen position of the text information to the closed caption decoder 2. In FIG. 1, the components corresponding to those shown in FIG. 4 are assigned the same reference numbers and their explanation is not repeated.

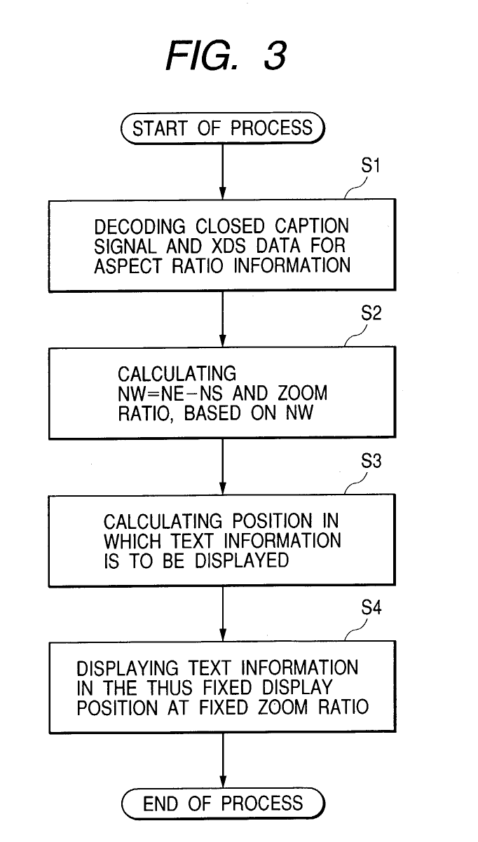

FIG. 3 is a flowchart illustrating a process flow for controlling on-screen position in which text information is to be displayed, according to the present invention. Using the flowchart of FIG. 3, the operation of the apparatus of FIG. 1 will be explained more specifically hereinafter.

When the video signal in which the closed caption signal and XDS data for aspect ratio information embedded in VBI is input to the closed caption decoder 2, the first step 1 (a step will be represented by S hereinafter) is executed in which the closed caption signal added to the video signal on VBI line 21, field 1 or 2 and the aspect ratio information in XDS data added to the video signal on VBI line 21, field 2, are extracted and decoded. The control data for on-screen position in which text information is to be displayed and the start line number NS and end line number NE are input to the microcomputer 4.

From the input start line number NS and end line number NE as the aspect ratio information, the microcomputer 4 calculates a vertical picture size NW by the following equation:

NW=NE−NS (Equation 1)

Based on the calculated picture size NW, the microcomputer 4 calculates an optimum zoom ratio and outputs the calculated optimum picture zoom ratio to the deflection control unit 3 (S2). The microcomputer 4 also calculates an on-screen position in which the text information from the closed caption signal should be displayed, accompanying the video picture, without falling out of the display area, and outputs the on-screen position of the text information to the closed caption decoder 2 (S3).

The deflection control unit 3 outputs the video signal passed from the video signal generating unit 1, the text information to be displayed in position controlled by the microcomputer 4, passed from the closed caption decoder 2, and the zoom ratio calculated by the microcomputer 4 to the cathode ray tube 5 display, so that the cathode ray tube 5 display shows an enlarged view of the video picture with the accompanying text information at the zoom ratio (S4).

Unlike the prior art video display apparatus, the video display apparatus of the present invention does not detect a picture size from the received video signal and, therefore, is free of incorrect picture size detection even upon the reception of a video signal of a low brightness scene or rapid motion scene. The invented apparatus can present a steady enlarged view of a picture and its accompanying caption, free of a happening that accompanying text information is missing.

While the video display apparatus described hereinbefore employs the cathode ray tube (CRT) as the display device, it should be appreciated that the display device employed in the apparatus of the present invention should not be limited to the CRT and any other type of display device such as a liquid crystal display or plasma display panel may be employed instead. In some embodiments using another type of display device, it may be preferable to use an image processing unit provided with a video memory and a zoom function, instead of the deflection control unit which is used as the means for zoom control. Because such image processing unit can be provided by publicly known technology, its detailed description is not provided herein. Of course, reasonably, a video signal from the video signal generating unit must be A-D converted before being input to the image processing unit.

It will be appreciated that the present invention is not limited to application in analog broadcasting and can be applied to cases where data supported by XDS for broadcast rendering control, for example, program rating information, closed caption information, and auxiliary control data for displaying video pictures such as aspect ratio information is added to a digital broadcast signal instead of an analog broadcast signal. For application in digital broadcasting such as, for example, a terrestrial digital broadcasting system in the US, recommended by the Advanced Television System Committee (ATSC), if at least the start line (start position) code and end line (end position) code of the aspect ratio information are added to a broadcast signal, a vertical picture size can be calculated from the position given by the start line code from which the horizontal scan starts and the position given by the end line code at which the horizontal scan terminates and the same control process as in the described embodiment can be performed. Such auxiliary control data for displaying video pictures is included in a transport stream of a video signal or audio signal, which differs from analog broadcast application.

As described hereinbefore, according to the present invention, closed captions can be presented steadily on a screen, accompanying a zoomed video picture when being displayed. The present invention avoids closed captions missing out of the screen of the television receiver and interfering with the displayed picture view.

What is claimed is:

1. A video display apparatus comprising:
closed caption decoder, which extracts a closed caption signal embedded in a video signal and derives closed caption information therefrom;
calculator which calculates a vertical picture size corresponding to an active picture area after extracting from the video signal a start line code which determines a position from which a horizontal scan starts along a vertical axis of the active picture area of the video signal and an end line code which determines a position at which the horizontal scan terminates, wherein the start line code and the end line code are included in a data signal embedded in the video signal; and
position controller which controls position in which said closed caption information is to be displayed on a display screen, according to the vertical picture size.

2. A video display apparatus according to claim 1, wherein:
said video signal is an analog video signal;
said closed caption decoder is configured to extract the closed caption signal added to the video signal in a vertical blanking interval; and
said calculator is configured to extract from an aspect ratio information signal added to the video signal in the vertical blanking interval the start line code which determines the position from which the horizontal scan starts along the vertical axis of the active picture area of the video signal and the end line code which determines the position at which the horizontal scan terminates.

3. A video display apparatus according to claim 1, wherein said display screen has an aspect ratio of 16:9.

4. A video display apparatus comprising:
closed caption decoder, which extracts a closed caption signal embedded in a video signal and derives closed caption information therefrom;
extractor which extracts from the video signal a start line code which determines a position from which a horizontal scan starts along a vertical axis of an active picture area of the video signal and an end line code which determines a position at which the horizontal scan terminates, wherein the start line code and the end line code are included in a data signal embedded in the video signal;
a calculator which calculates a vertical picture size corresponding to the active picture area from the start line code and the end line code, setting a zoom ratio from the vertical picture size, and zooming a picture from the video signal in the active picture area at the zoom ratio; and
position controller which controls position in which said closed caption information is to be displayed at the zoom ratio on a display screen, according to the positional data for displaying the closed caption and the zoom ratio.

5. A video display apparatus according to claim 4, wherein:
said video signal is an analog video signal;
said closed caption decoder is configured to extract the closed caption signal added to the video signal in a vertical blanking interval; and
said calculator is configured to extract from an aspect ratio information signal added to the video signal in the vertical blanking interval the start line code which determines the position from which the horizontal scan starts along the vertical axis of the active picture area of the video signal and the end line code which determines the position at which the horizontal scan terminates.

6. A video display apparatus according to claim 4, wherein said display screen has an aspect ratio of 16:9.

7. A video display apparatus having a wide display screen with a wider aspect ratio, comprising:
a closed caption decoder which extracts and decodes a closed caption signal added to a video signal in a vertical blanking interval and derives closed caption information from the caption signal, and extracts and decodes an aspect ratio information signal which is an extended data service signal added to the video signal in the vertical blanking interval and derives aspect ratio information from the aspect ratio information signal;
zooming and displaying controller which zooms and displays a picture from the video signal and said closed caption information on the display screen; and
calculator and position controller which performs the following:
calculating a vertical picture size corresponding to an active picture area from a start line code which determines a position from which a horizontal scan starts along a vertical axis of the active picture area of the video signal and an end line code which determines a position at which the horizontal scan along the vertical axis of the active picture area terminates, the start line code and the end line code being included in said aspect ratio information and received from said closed caption decoder;
calculating a zoom ratio of zooming the picture from the video signal in the active picture area on the display screen, based on the vertical picture size and controlling zooming by said zooming means; and
controlling position in which said closed caption information is to be displayed at the zoom ratio on the display screen, according to positional data for displaying the closed caption, the positional data being included in said closed caption information and received from said closed caption decoder,
wherein the video display apparatus displays the picture from the video signal accompanied by said closed caption information at the zoom ratio in the active picture area, so that the closed caption does not fall out of the display screen.

8. A video display apparatus according to claim 7, wherein said display apparatus is a projection type and has the display screen with an aspect ratio of 16:9.
